(19) United States
(12) Patent Application Publication
(10) Pub. No.: US 2010/0063934 A1
(43) Pub. Date: Mar. 11, 2010

(54) Travel Planning for Social Networks

(76) Inventor: Denis Khoo, Arcadia, CA (US)

Correspondence Address: DILLON & YUDELL LLP, 8911 NORTH CAPITAL OF TEXAS HWY, SUITE 2110, AUSTIN, TX, 78759, US

(21) Appl. No.: 12/620,533

(22) Filed: Nov. 17, 2009

Related U.S. Application Data
(62) Division of application No. 10/884,357, filed on Jul. 2, 2004.

(51) Int. Cl. G06Q 50/00; G06Q 99/00

(52) U.S. Cl. 705/319

(57) ABSTRACT

A method and system is described for providing a traveler with the ability to query an electronic social network for travel related information. The traveler, and related individuals, enter future travel plans into the system. The traveler leverages this information by querying the system to determine which related individuals will be at the same travel location for a future date. The traveler is also able to query the system to determine when next a related individual will be at a particular location. The travel can also query the system to determine where related individuals will be for a future date.

### CROSS-REFERENCE TO RELATED APPLICATIONS

This application is a divisional of pending U.S. patent application Ser. No. 10/884,357, filed on Jul. 2, 2004, titled “Travel Planning for Social Networks,” the entirety of which is incorporated herein by reference.

### BACKGROUND OF THE INVENTION

1. Field of the Invention

The present invention relates generally to travel planning, and more particularly, to travel planning in conjunction with an electronic social network.

2. Description of the Related Art

Several decades ago, most people considered traveling out of town a rare event. However, in today's high tech and fast paced environment, individuals find themselves traveling much more frequently for both business and pleasure. Also contributing to the increase in out of town travel is the lowered cost of travel and the increased efficiency of travel. Individuals now have several modes of travel to choose from, including car, boat, train, and plane.

Travelers, especially business travelers, are finding themselves traveling alone and for extended periods. They are also finding that they are traveling to destinations completely foreign and unfamiliar to them. Whether or not they are traveling alone, travelers typically would like the opportunity to find and meet with related individuals, such as friends, family members, business associates, or even friends of friends while at their travel destination.

Typically, in order to accomplish this task, the traveler would first have to perform the step 100 of keeping track of related individuals by using a paper or electronic organizer. Upon completing the step 110 of determining travel plans, the traveler must then perform the step 120 of contacting each related individual in order to determine if that related individual will be at the same location within the same date range. If the related individual's contact information is out of date, the traveler needs to take the additional step 150 of figuring out the updated contact information. Once the step 140 of contacting the related individual is completed, the traveler can determine whether or not the related individual will be at the same location within the same date range. If so, the traveler can then take the step 170 of noting this and making arrangements to meet with the related individual.

There is a need for a more convenient way of allowing a traveler to discover related individuals that a traveler can meet with. A traveler should be able to easily discover which related individuals, if any, will be at the destination at the same time that the traveler will be. The traveler should not have to personally contact every friend, family member, business associate, etc., to discover this information as they would today. Once the traveler discovers which related individuals will be in the same geographical proximity on a given date, the traveler can then contact those related individuals and make arrangements to meet.

There are several online social networks on the internet today, such as Friendster, Orkut, and Plaxo. An online social network allows an individual to easily keep track of relationships that the individual has with other people by leveraging the internet. Each individual maintains his or her own account profile on the online social network, and defines who his or her related individuals are. Once defined, the online social network retains the relationship.

FIG. 2a, FIG. 2b, FIG. 2c, FIG. 2d, and FIG. 2e represent relationship diagrams to provide a better understanding of online social networks. In this example, all relationships are symmetrical, meaning if User A 200 is a related individual of User B 210, then User B 210 must be a related individual of User A 200. An online social network need not have such a symmetrical relationship. In FIG. 2a, User A 200 defines his relationship with three related individuals, User B 210, User C 220, and User D 230. Each of these three related individuals have their own relationship to their own related individuals. The relationship diagram in FIG. 2b reveals User B's 210 related individuals. As shown, User B's related individuals are User A 200, User C 220, User E 240, and User F 250. FIG. 2c shows that User C's 220 related individuals are User A 200, User B 210, User F 250, and User G 260. FIG. 2d shows that User D's 230 related individuals are User A 200, User G 260, User H 270, User 1280, and User J 290. In FIG. 2e, User A's 200 related individuals are shown, with up to two degree of separation. User A's 200 related individuals at one degree of separation include User B 210, User C, 220, and User D 230. User A's 200 related individuals at two degree of separation include User E 240, User F 250, User G 260, User H 270, User 1280, and User J 290.

The advantages of an electronic social network are numerous. An electronic social network is able to maintain a list of related individuals for a member. Since an electronic social network stores a relationship (or link) to a related individual from a member, data about a related individual is managed by the related individual. For example, the electronic social network keeps a link between User A and User B. If User A's phone number changes, there is no need for User B to make the update. User A updates his/her phone number on the electronic social network, and the update is automatically reflected to User B. Similarly, the electronic social network also has a link between User A and User C, and thus User C would also sees User A's new phone number. Another advantage of an electronic social network is the ability to see related individuals at multiple levels of separation. Users of the electronic social network can see friends of friends, or others within two degree of separation. Of course, viewing users at more than two degree of separation is also possible.

### SUMMARY OF THE INVENTION

The present invention provides a method for travelers to easily discover where related individuals were, is, and will be geographically located. A related individual is an individual with whom the traveler has a relationship with, such as a friend of the traveler, a relative of the traveler or a business associate of the traveler. A related individual can also include a friend of a friend. Using an electronic social network, the traveler will identify related individuals with one degree of separation, and perhaps their relationships. The traveler's related individuals will inform the system of their present and future whereabouts. This will allow the traveler to discover where related individuals are currently located, and where they will be located for any given future date. The traveler can also inform the system about his/her current and future whereabouts, and let the system determine which related individuals will be nearby for the present and future respectively.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a flowchart diagram of the prior art.

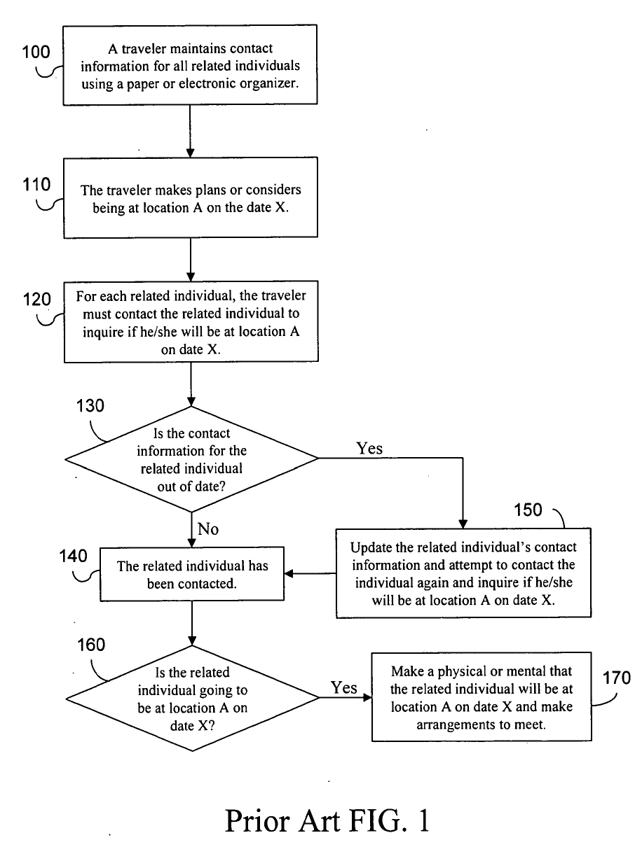

FIG. 2a is relationship diagram of an electronic social network.

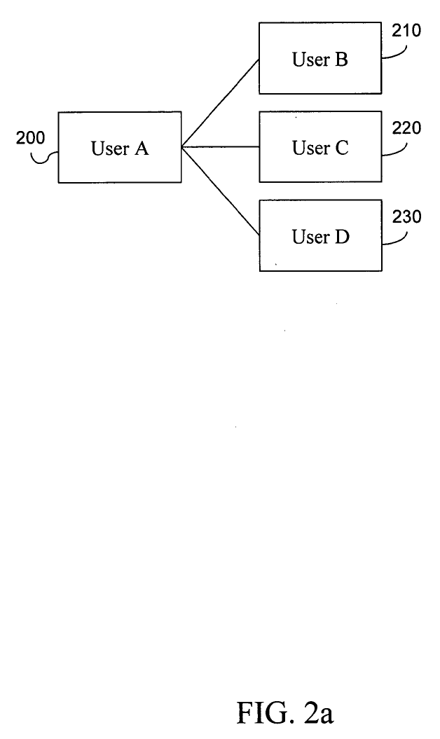

FIG. 2b is relationship diagram of an electronic social network.

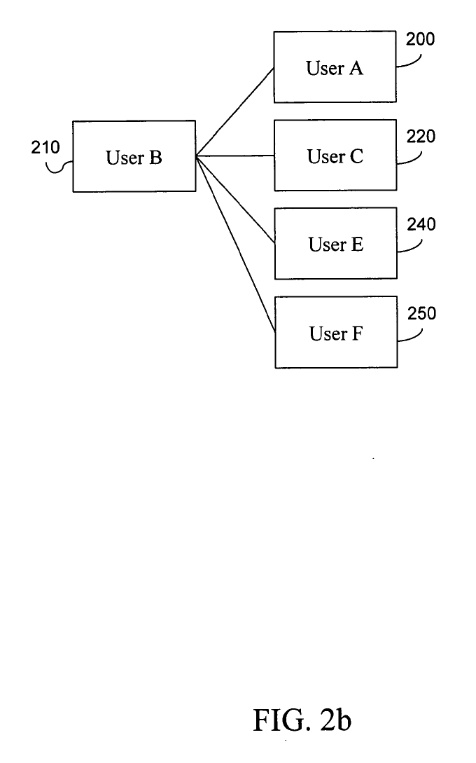

FIG. 2c is relationship diagram of an electronic social network.

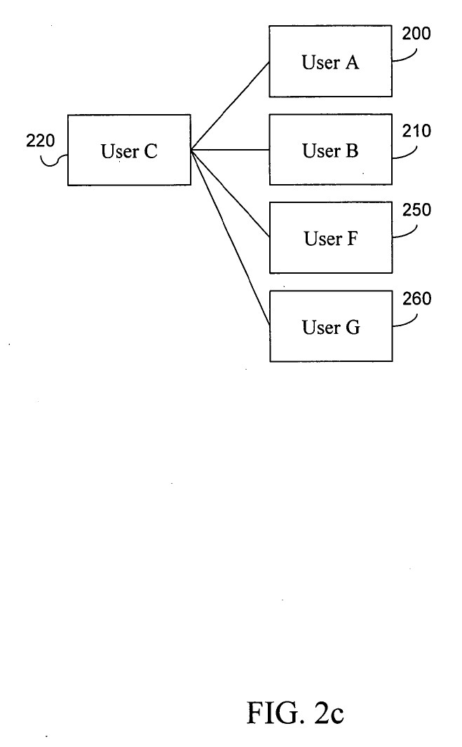

FIG. 2d is relationship diagram of an electronic social network.

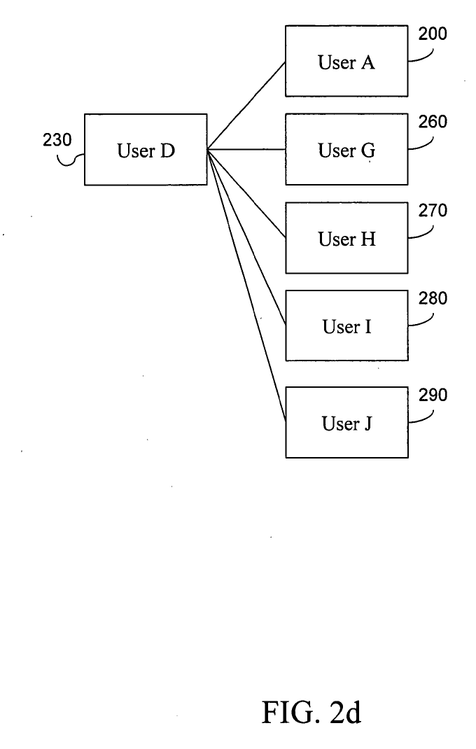

FIG. 2e is relationship diagram of an electronic social network.

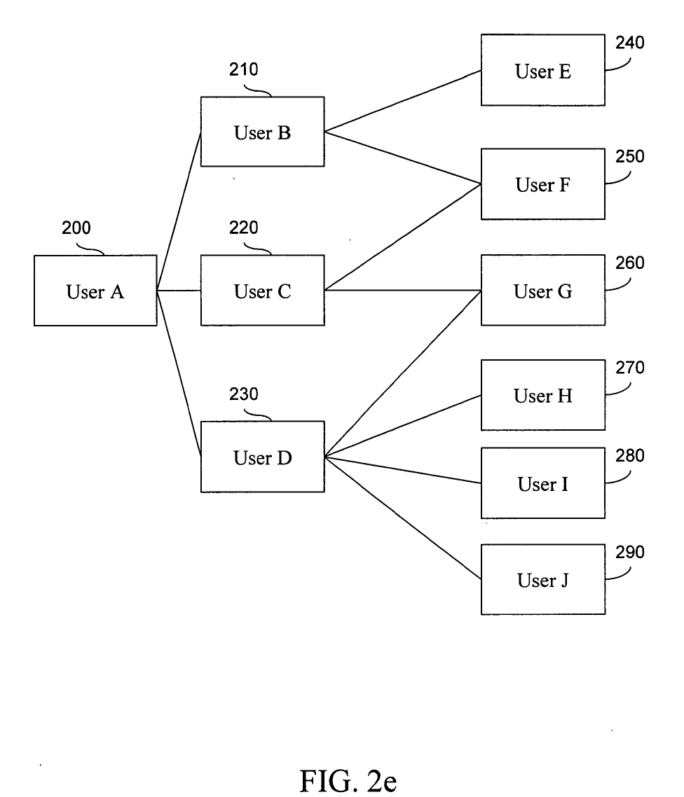

FIG. 3 is a flowchart diagram of an embodiment of the present invention.

FIG. 4 is a technical block diagram of an embodiment of the present invention.

FIG. 5 is a detailed technical block server diagram of an embodiment of the present invention.

FIG. 6 is a user interface diagram for inputting the social network user's future travel plans.

FIG. 7 is a user interface diagram for requesting the future location of related individuals.

FIG. 8 is a view for reporting the location of related individuals.

FIG. 9 is a user interface diagram for requesting the future location of related individuals within a map view.

FIG. 10 is a map view for reporting the location of related individuals.

### DETAILED DESCRIPTION OF PREFERRED EMBODIMENTS

### System Overview

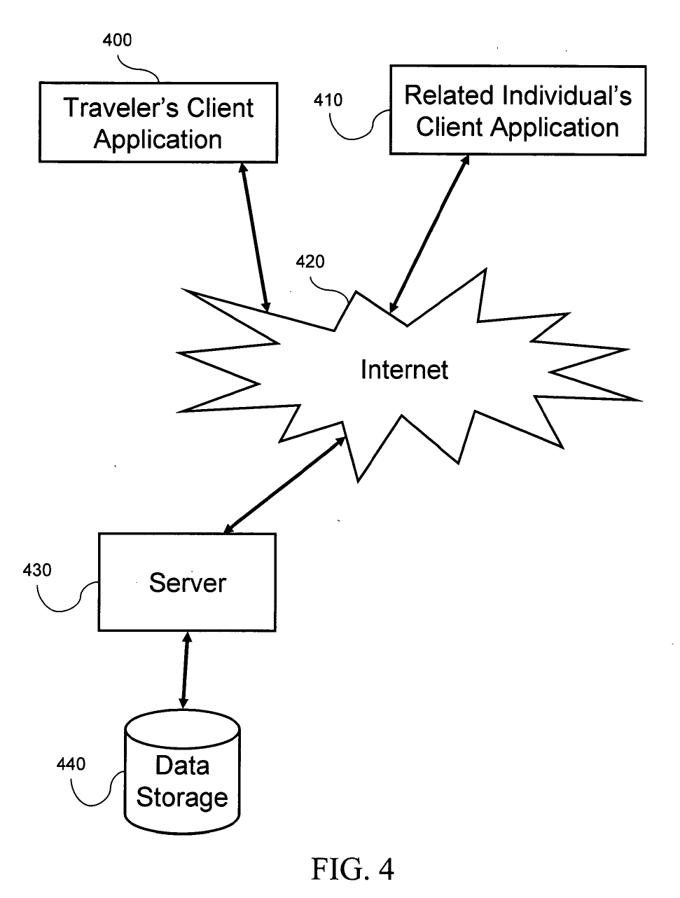

FIG. 4 is a high level technical diagram of an embodiment of the present invention. A traveler interacts with the system by using a client application 400 which is connected to the internet 420 and communicates with the server 430. Similarly, one or more related individual of the traveler also use a client application 410 which is connected to the internet 420 and communicates with the server 430. The server 430 contains application logic for inputting travel plans and using this data for advanced reporting. The server 430 is also used to manage all logic involved with an electronic social network. All persistent data is stored by the server 430 onto a data storage device 440 such as a database.

### Methodology

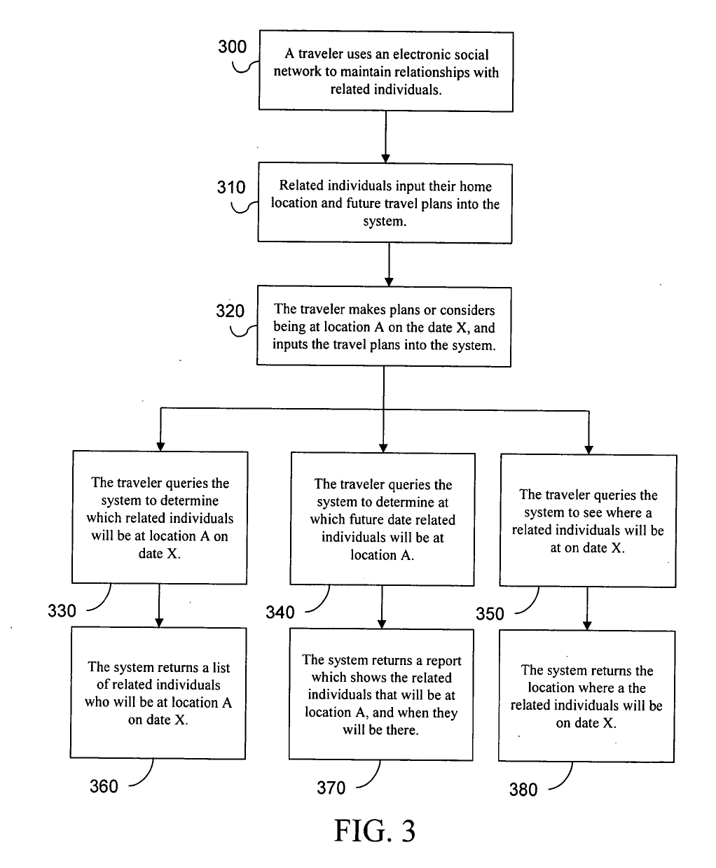

FIG. 3 is a flow chart of an embodiment of the present invention. In the first step 300, a traveler uses a client application 400 to interface with an electronic social network running on the server 430 to maintain his/her relationship with related individuals. Data about the traveler and related individuals, along with their relationships are persisted in the data storage device 440. In the next step 310, related individuals, using a client application 410, input their current location and future travel plans into the system, which ultimately gets registered by the server 430 and stored onto the data storage 440. Related individuals are able to add, remove, and edit future travel plans. Related individuals can also modify their current location.

In step 320, the traveler makes plans to travel or is considers traveling. The traveler's destination or intended destination, if any, is designated as location A on the date X. The traveler enters this information into the system via the client application 400.

With travel plans in mind, the traveler may be curious about which related individuals he/she can meet with while at location A. In this system, the traveler is able to query for this information in three different fashions. First is via step 330 whereby the traveler queries the system to determine which related individuals will also be at location A on date X. In step 360, the system returns a list of all related individuals who will be at location A on date X. The system will return an empty list if it cannot find any related individuals that will also be at location A on date X.

The second means by which the traveler can query the system is via step 340 whereby the traveler queries the system to discover when in the future related individuals will be at location A. If the traveler is flexible, the traveler will be able to use this information to influence when the traveler decides to travel to location A. In step 370, the system returns a report revealing the related individuals who will be at location A sometime in the future, and the dates when they will be at location A.

The third means by which the traveler can query the system is via step 350 whereby the traveler queries the system to see where related individuals will be on date X. This allows the traveler to see where the traveler's related individuals will be for a future date. In step 380, the system returns with information revealing the location of related individuals for date X. This can be displayed in a list format or can be displayed on a map for easier viewing.

### Comprehensive Example

FIG. 4 shows at a high level how the users interact with the system of this invention, and how different pieces of the system are interconnected. The traveler interacts with this system via a client application 400, and similarly, the related individuals interact with this system via a client application 410. The traveler's client application 400 and related individuals' client application 410 both connect to a server 430 by going over the internet 420. The server 430 uses a data storage device 440 for data persistence.

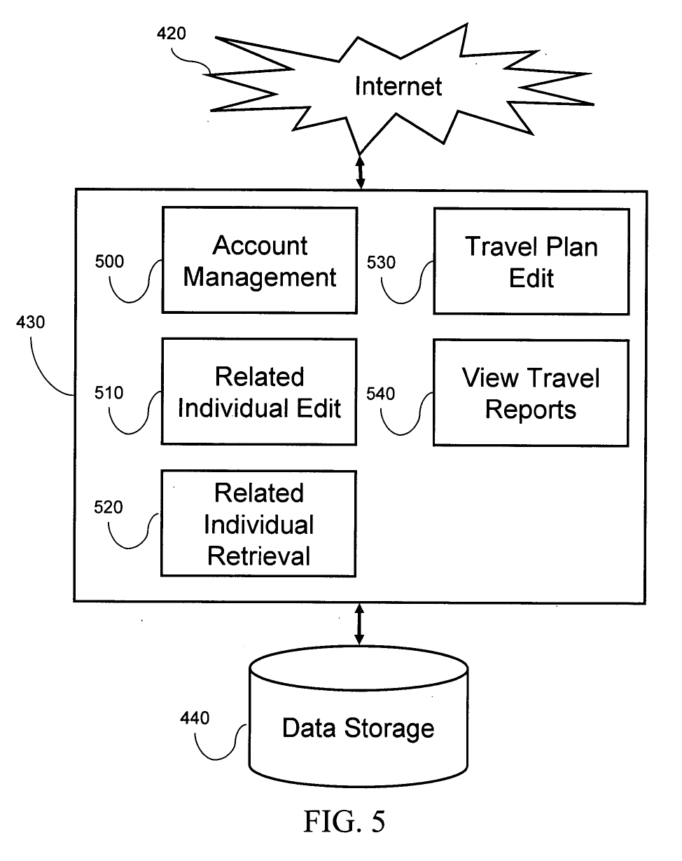

FIG. 5 is a detailed technical diagram of an embodiment of the present invention. The server 430 contains several modules where business logic resides for handling an electronic social network and for handling travel related functions. The business logic modules responsible for the electronic social network include Account Management 500, Related Individual Edit 510, and Related Individual Retrieve 520. The modules responsible for the travel related functions include Travel Plan Edit 530 and View Travel Reports 540.

The Account Management module 500 is used to manage basic account features for each member of the electronic social network. Basic account features include creating a new account, modifying an existing account, logging into an existing account, and removing an existing account. Some properties of an account include username, password, first name, last name, address, phone number, photos, interests, work information, email address, and credit card information. Anytime a user performs account related functionality, it is the responsibility of the Account Management module 500 to handle the request. Account information is persisted on the data storage 440.

The Related Individual Edit module 510 allows a member of the electronic social network to add a relationship to a related individual, edit a relationship to a related individual, and remove a relationship to a related individual. Typically, in order to have a relationship to a particular related individual on the electronic social network, that particular related individual must be a member and have an account set up with the electronic social network. The electronic social network member uses the Related Individual Edit module 510 to manage only related individuals within one degree of separation from the member. The electronic social network member need not manage related individuals within degrees of separation of two or more, as this is handled by the system automatically. Relationships to a related individual are persisted on the data storage 440.

The Related Individual Retrieval module 520 handles the request of returning a list of related individuals for a particular member. The request may specify the degrees of separation. For example, a social network member may request all related individuals within one degree of separation, which would prompt module 520 to return all related individuals for which the social network member has a direct relationship with. In another example, a social network member may request all related individuals within two degree of separation, which would prompt module 520 to return all related individuals for which the social network member has a direct relationship with, along with all related individuals that they have a direct relationship with.

The Travel Plan Edit module 530 allows a member of the social network to add a travel plan, edit a travel plan, and remove a travel plan. A travel plan includes properties such as the beginning date, ending date, destination, and purpose of travel. All travel plan data is persisted on the data storage 440 connected to the server 430.

The View Travel Reports module 540 is responsible for handling various requests related to discovering the location of a related individual for a future date. There are three major types of request that the module 540 can accept. First is a request for all related individuals at a specified location for a specified date. Second is the location of related individuals for a specified date. Third is the future date when a related individual will be at a specified location.

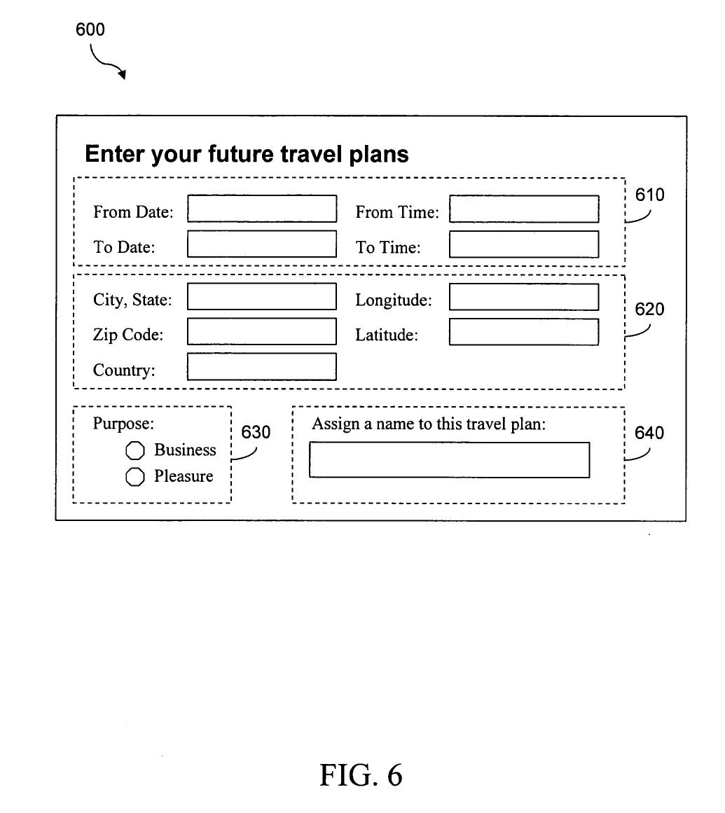

FIG. 6 shows a user interface for users of an electronic social network to enter their future travel plans. This user interface would be displayed on the traveler's client application 400 or the related individuals' client application 410. The traveler and related individuals are able to enter their future plans using this interface, which accomplishes step 310 and step 320. On this user interface 600, users can enter the date and time range for their future travel plans (610), plus the location where they will be traveling to (620). Travel location can be entered using a variety of information, such as city, state, and country, or zip code, or even the longitude and latitude. In this embodiment, the purpose for travel is also selectable (630), and a name can be assigned to each travel plan entered (640).

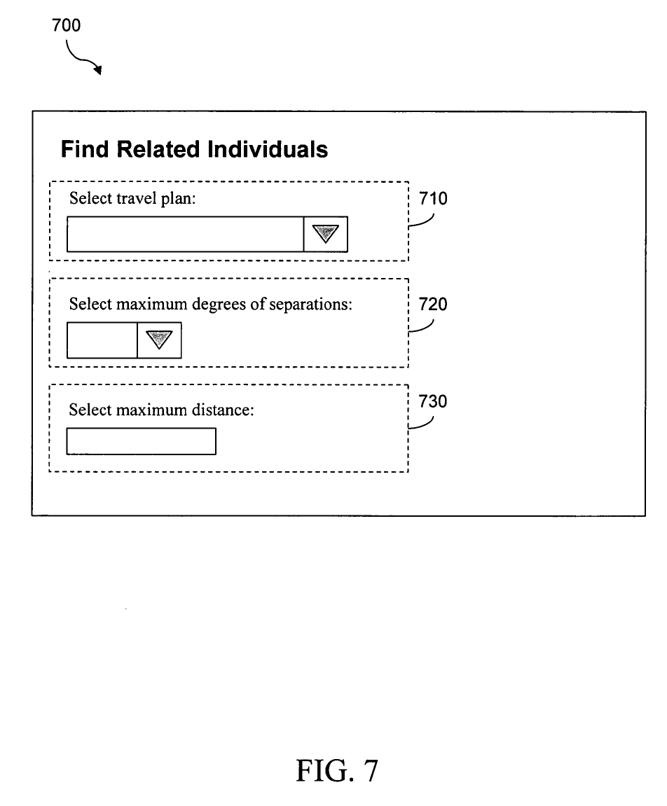

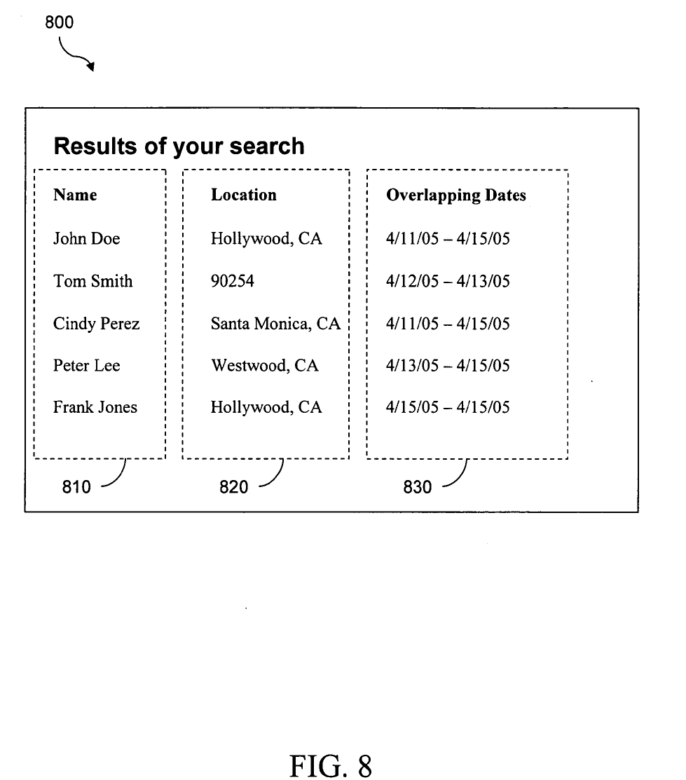

In step 330, the traveler is able to discover related individuals in the same future location at the same future time. The user interface for inputting this query is displayed in FIG. 7. The user interface 700 allows the traveler to specify his/her future travel plan by selecting it from a drop down menu 710. The traveler is also able to specify the maximum degrees of separation to search for via the drop down 720. For example, if the traveler chooses “1” as a selection here, the system will limit search results to only related individuals with one degree of separation from the traveler. The traveler is also able to specify the maximum distance a related individual can be from the traveler by entering the maximum distance in the textbox 730. FIG. 8 is a display of a sample result from the query performed via the user interface 700. As shown, the system returns a list of related individuals who will be near the same future location and same future time as the traveler. The search result includes the related individual's name 810, along with the location where the related individual will be located 820. The search result also shows the specific future dates 830 for when these related individuals will be in the same future location. This search result satisfies step 360.

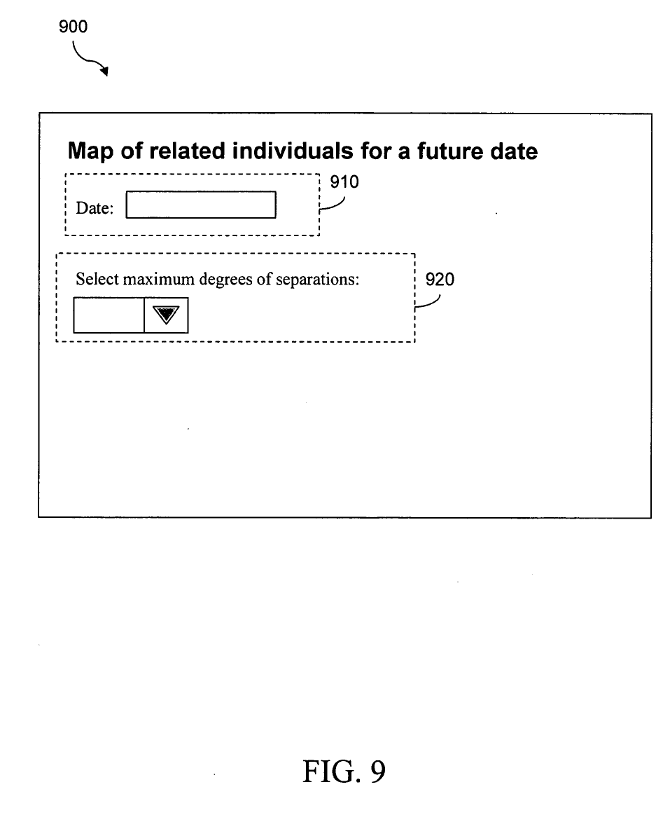

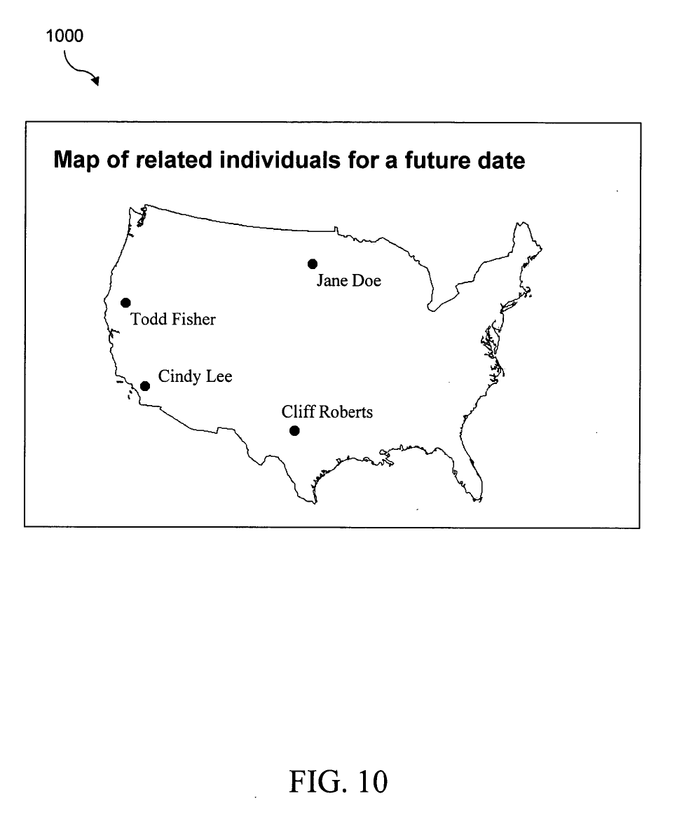

In step 350, the traveler is able to query the system to see where related individuals will be at on a future date. One method of doing so is by submitting a query as shown in FIG. 9. The user interface 900 allows the traveler to specify a future date 910, and the maximum degrees of separation 920. FIG. 10 shows a graphical search result for the query submitted from the user interface 900. FIG. 10 shows where each related individual will be for the future date specified. Each related individual is plotted on a map, which provides a much more user friendly view for the traveler. The map may be customized to show the entire globe, or to be zoomed into one geographical area. This search result satisfies step 380.

With such a system, a traveler is given the opportunity to efficiently schedule meetings and get together with related individuals. These related individuals, as mentioned earlier, may be friends, co-workers, business associates, relatives, etc. The advantage of being able to meet with a related individual while traveling may be advantageous from a business viewpoint, and may also make the travels more enjoyable. In many cases, travelers will find themselves scheduling their travel plans around their related individuals' travel plans. The system allows for this capability as well. With this system, travelers will no longer have to miss an opportunity to meet and get together with related individuals. With this system, travelers will no longer waste time seeking related individuals when planning to travel.

Although the present invention has been described in detail with respect to certain embodiments and examples, variations and modifications exist which are within the scope of the present invention as defined in the following claims.

1. A computer-implemented method comprising:
receiving a travel plan at an electronic social network on an Internet, wherein the travel plan indicates a purpose of travel for a traveler;
storing the traveler's travel plan in a database storage device coupled to a server hosting the electronic social network;
receiving a travel plan at the electronic social network on the Internet indicating a purpose of travel for an individual related to the traveler, wherein the related individual is related to the traveler through the electronic social network;
storing the related individual's travel plan in the database storage device;
comparing the traveler's travel plan with the related individual's travel plan;
determining a match between the respective purposes of travel indicated in the traveler's travel plan and the related individual's travel plan;
if a match is determined, generating a search result identifying the travel plan of the related individual, wherein the search result specifies one or more dates and a destination identified in the related individual's travel plan associated with the matched purpose of travel; and
transmitting the search result from the server over the Internet for display to the traveler through the electronic social network.

2. The computer-implemented method of claim 1, wherein a travel plan includes properties of a beginning date, ending date, destination and purpose of travel.

3. The computer-implemented method of claim 1, wherein the step of determining a match further comprised determining a match between each of the respective destinations, one or more dates and purposes of travel indicated in the traveler's travel plan and the related individual's travel plan.

4. The computer-implemented method of claim 3, wherein the destinations match when they are geographically within a defined maximum distance of one another, wherein the maximum distance is defined in response to an input received from the traveler through the electronic social network.

5. The computer-implemented method of claim 3, wherein the destinations match when they indicate the same city.

6. The computer-implemented method of claim 1, wherein at least one of the purpose of travel for the related individual and the purpose of travel for a traveler is business.

7. The computer-implemented method of claim 1, wherein the related individual is one degree of separation from the traveler.

8. The computer-implemented method of claim 1, wherein the related individual is multiple degrees of separation from the traveler.

9. The computer-implemented method of claim 1, wherein the step of transmitting includes transmitting data representing a graphical search result on a map.

10. The computer-implemented method of claim 1, further comprising the step of:
receiving a query from the traveler requesting one or more related individuals to the traveler having a travel plan indicating a purpose and performing the comparing in response to the query.

11. A system comprising:
a processor;
a memory medium coupled to the processor; and
a network interface coupled to the processor;
wherein the memory medium includes instructions, which when executed by the processor, cause the system to perform:
receiving a travel plan at an electronic social network on an Internet, wherein the travel plan indicates a purpose of travel for a traveler;
storing the traveler's travel plan in a database storage device coupled to a server hosting the electronic social network;
receiving a travel plan at the electronic social network on the Internet indicating a purpose of travel for an individual related to the traveler, wherein the related individual is related to the traveler through the electronic social network;
storing the related individual's travel plan in the database storage device;
comparing the traveler's travel plan with the related individual's travel plan;
determining a match between the respective purposes of travel indicated in the traveler's travel plan and the related individual's travel plan;
if a match is determined, generating a search result identifying the travel plan of the related individual, wherein the search result specifies one or more dates and a destination identified in the related individual's travel plan associated with the matched purpose of travel; and
transmitting the search result from the server over the Internet for display to the traveler through the electronic social network.

12. The system of claim 11, wherein a travel plan includes properties of a beginning date, ending date, destination and purpose of travel.

13. The system of claim 11, wherein determining a match further comprises determining a match between each of the respective destinations, one or more dates and purposes of travel indicated in the traveler's travel plan and the related individual's travel plan.

14. The system of claim 13, wherein the destinations match when they are geographically within a defined maximum distance of one another, wherein the maximum distance is defined in response to an input received from the traveler through the electronic social network.

15. The system of claim 13, wherein the destinations match when they indicate the same city.

16. The system of claim 11, wherein at least one of the purpose of travel for the related individual and the purpose of travel for a traveler is business.

17. The system of claim 11, wherein the related individual is one degree of separation from the traveler.

18. The system of claim 11, wherein the related individual is multiple degrees of separation from the traveler.

19. The system of claim 11, wherein transmitting includes transmitting data representing a graphical search result on a map.

20. The system of claim 11, further comprising the function of:
receiving a query from the traveler requesting one or more related individuals to the traveler having a travel plan indicating a purpose and performing the comparing in response to the query.
